(19) United States
(12) Patent Application Publication
(10) Pub. No.: US 2020/0019343 A1
(43) Pub. Date: Jan. 16, 2020

(54) METHOD AND APPARATUS FOR A DURABLE LOW LATENCY SYSTEM ARCHITECTURE

(71) Applicant: Nutanix, Inc., San Jose, CA (US)

(72) Inventor: Dmitri BRONNIKOV, Foster City, CA (US)

(73) Assignee: Nutanix, Inc., San Jose, CA (US)

(21) Appl. No.: 16/035,359

(22) Filed: Jul. 13, 2018

(51) Int. Cl. G06F 3/06; H04L 29/08

(52) U.S. Cl. CPC G06F 3/0659; H04L 67/1097; G06F 3/067; G06F 3/0611; G06F 3/0664; G06F 3/0604

(57) ABSTRACT

A method and apparatus for a durable low latency system architecture. The method includes providing an apparatus that includes a battery backup electrically coupled to a motherboard, and to a non-volatile storage device (either through additional circuitry to through the motherboard itself). The process leverages the battery backup to allow for durably maintaining write requests in volatile memory while the system is operating on standard input power. When the system switches to battery power the write requests maintained in the volatile memory are persisted in a non-volatile storage device using the battery power. Thus, the write requests are durably maintained in a RAM where they are only copied to a persistent storage location that is not the write request target location when there is a failure of the power input to the system.

### FIELD

This disclosure concerns a method and apparatus for a durable low latency system architecture.

### BACKGROUND

Current methods and apparatus for durable systems implement resource intensive persistence methods to ensure that data is reliably captured. These methods are consume large amounts of storage resources (both volatile and non-volatile), communications bandwidth, and processing resources within any given device to manage incoming data in a durable manner. In particular, current methods write data to both a volatile memory and a non-volatile memory to maintain accessibility and durable persistence. Additionally, these methods employ different formats to store data in volatile vs non-volatile which further adds an additionally processing burden.

Generally, the data corresponding to incoming writes are initially stored in a persistent storage structure called write ahead log (WAL). Using the WAL as a temporary holding place, a device can store the corresponding data in its target location without holding up the transmitting device and without undue risk of loss of the corresponding data—e.g. the WAL persists corresponding data to allow for acknowledgement of receipt without waiting for the corresponding data to be written to its target location (e.g. a network storage device/appliance). The WAL is normally maintained in a non-volatile storage device connected to the device for quick access, such as a solid-state drive (SSD), a hard disk drive (HDD), or a hybrid drive (one that combines aspects of SSDs and HDDs). However, such drives are relatively slow and are not configured for direct writing to another device or location—e.g. data to be written must first be placed in volatile storage before being transmitted to a corresponding target location. Furthermore, data for managing the WAL and the data stored volatile memory must be maintain so that incoming write requests can be processed in an orderly and consistent manner.

Because incoming writes are stored in both non-volatile and volatile memory additional bandwidth is used to move the corresponding data around. Furthermore, volatile memory space is often at a premium which sometimes cause the same data to be copied into volatile memory multiple times further consuming bandwidth (e.g. a first time to service any corresponding accesses, and a second time to facility writing to a target location after that data was previously evicted by a higher priority data).

The management and movement of this data causes the consumption of processing resources. For example, the incoming writes must be identified for persisting their corresponding data in the write ahead log, entries in the WAL must be managed by the processor to insure that they are persisted at their target location in the correct order, and the entries in the WAL must be maintained and processed when read requests are received for corresponding data to insure that the latest data (e.g. the data in the WAL or a copy thereof in volatile storage) is used to serve read requests as opposed to outdated data that is stored at the target location—where the data at target location is outdated because a corresponding write has not yet been persisted to that target location. Furthermore, data that is copied into the WAL will often undergo a transformation that consumes additional processing resources, such as serializing the data for storage in the WAL.

Therefore, what is needed is are improved durable systems that insure data is reliably captured without being so resource intensive.

### SUMMARY

The present disclosure concerns a method and apparatus for a durable low latency system architecture. Generally, the inventive approach provides an apparatus that includes a battery backup electrically coupled to a motherboard, and to a non-volatile storage device (either through additional circuitry or through the motherboard itself). The process leverages the battery backup to allow for durably maintaining write requests in volatile memory while the system is operating on standard input power (e.g. line power from a commercial power supplier). However, when the apparatus switches to battery power the write requests maintained in the volatile memory are persisted in a non-volatile storage device. Thus, the write requests are durably maintained in a volatile storage (e.g. Random Access Memory) where they are only copied to a persistent storage location that is not the write request target location when there is a failure of the power input to the system.

Further details of aspects, objects, and advantages of the disclosure are described below in the detailed description, drawings, and claims. Both the foregoing general description and the following detailed description are illustrative and explanatory and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1A-G illustrate an approach for a method and apparatus for a durable low latency system architecture in accordance with some embodiments.

FIG. 2 illustrates a flowchart for a durable low latency system architecture in accordance with some embodiments.

FIG. 3 illustrates an example table for managing write request data for a durable low latency system architecture in accordance with some embodiments.

FIG. 4A illustrates a virtualized controller as implemented by the shown virtual machine architecture in which some embodiments are implemented.

FIG. 4B illustrates a virtualized controller implemented by a containerized architecture in which some embodiments are implemented.

FIG. 5 is a block diagram of an illustrative computing system suitable for implementing an embodiment of the present invention.

### DETAILED DESCRIPTION OF THE EMBODIMENTS OF THE INVENTION

The present disclosure concerns a method and apparatus for a durable low latency system architecture.

Various embodiments are described hereinafter with reference to the figures. It should be noted that the figures are not necessarily drawn to scale. It should also be noted that the figures are only intended to facilitate the description of the embodiments and are not intended as an exhaustive description of the invention or as a limitation on the scope of the invention. In addition, an illustrated embodiment need not have all the aspects or advantages shown. An aspect or advantage described in conjunction with a particular embodiment is not necessarily limited to that embodiment and can be practiced in any other embodiments even if not so illustrated. Also, reference throughout this specification to “some embodiments” means that a particular feature, structure, material or characteristic described in connection with the embodiments is included in at least one embodiment. Thus, the appearance of the phrase “in some embodiments” in various places throughout this specification is not necessarily referring to the same embodiment.

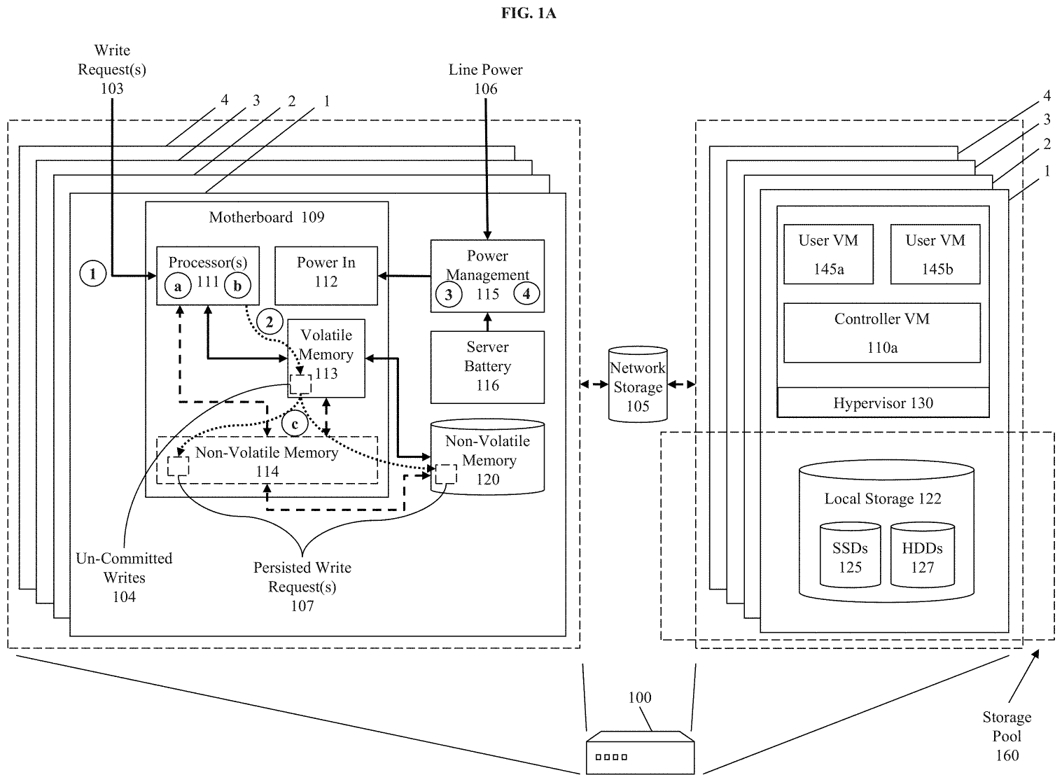

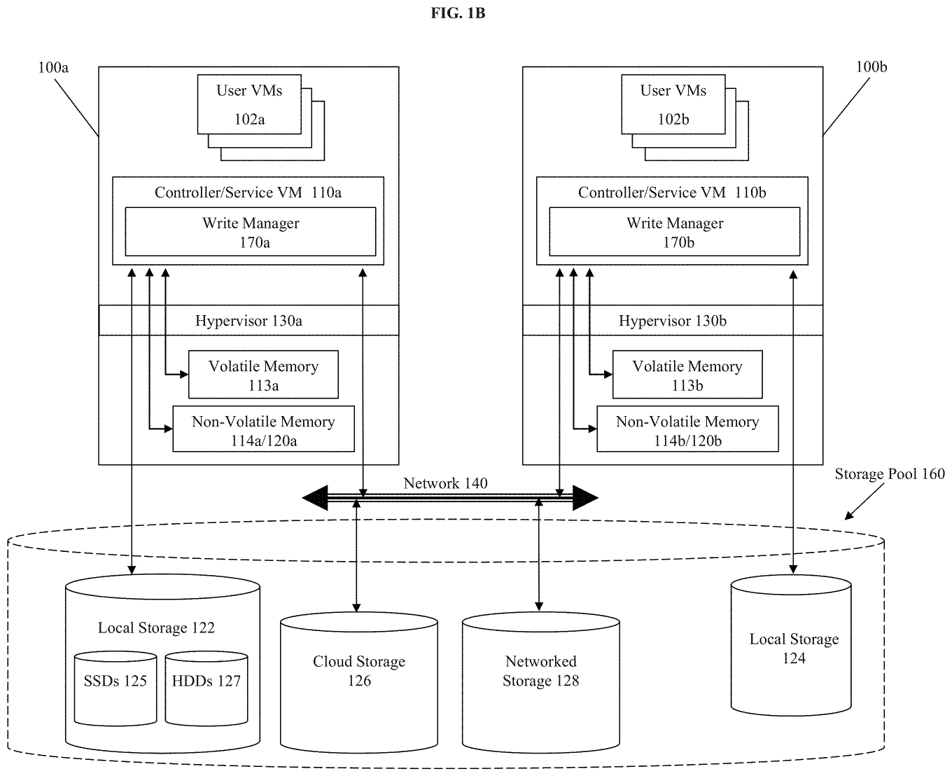

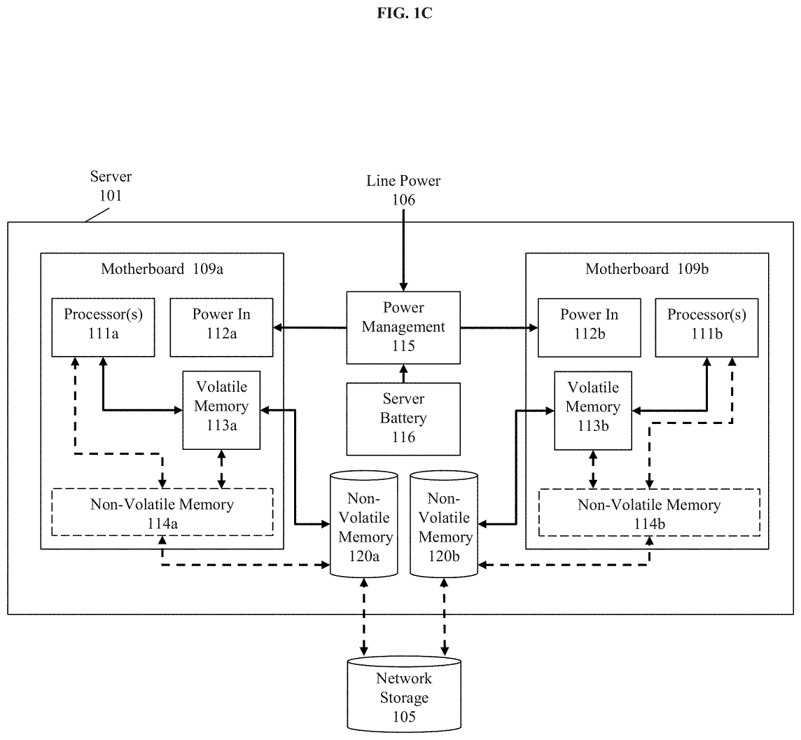

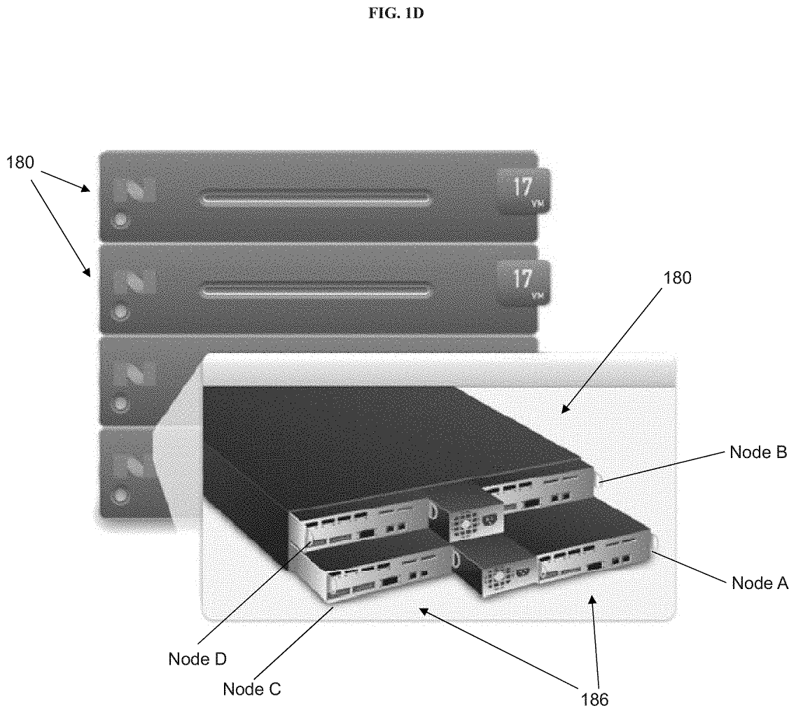

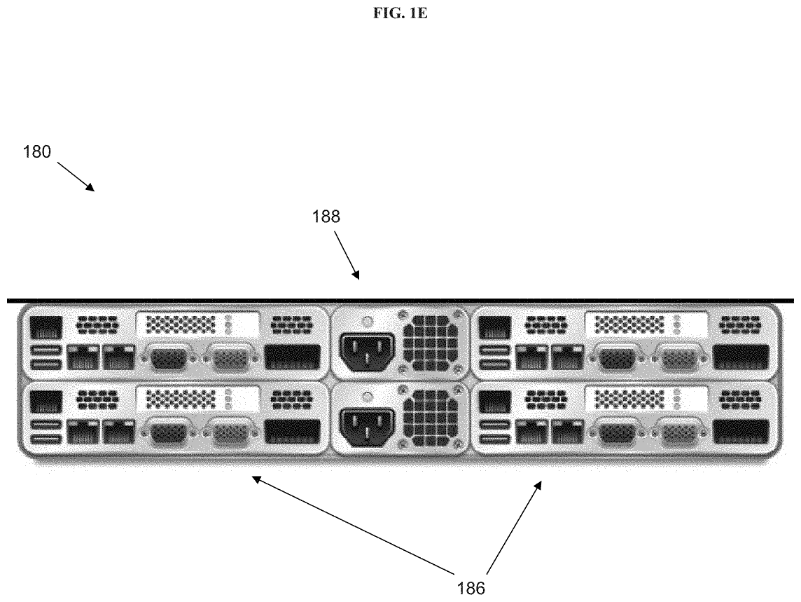

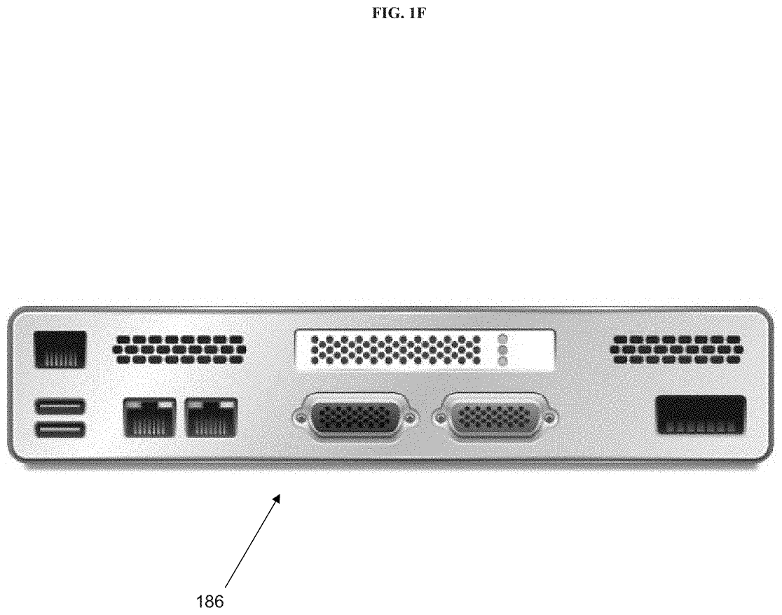

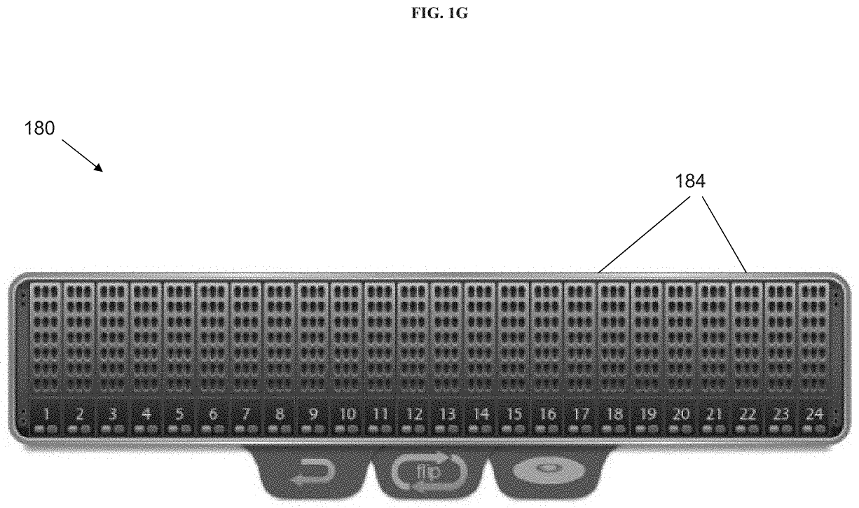

FIG. 1A-G illustrate an approach for a method and apparatus for a durable low latency system architecture in accordance with some embodiments. Generally, the method and apparatus include processes and apparatus for durably maintaining data. In contrast to prior art, the method/apparatus reserves or utilizes assigned backup power maintain the durability in volatile memory. For instance, a motherboard or computing device being connected to a battery backup is assigned/reserved a specified amount of battery power which will persist data stored in the non-volatile storage even if the main power input to the computing device fails. Additionally, in the event that the main power input fails the persisted data in the volatile storage will be transferred to an attached storage device to persist that data in the non-volatile storage before the backup power is exhausted. This essentially flips the prior techniques that by default persist data in a non-volatile storage—e.g. the disclosed technique stores the persisted data in the volatile storage by default. Furthermore, as will be explained further below, the process can be utilized in a hyperconverged virtualization environment.

FIG. 1A illustrates an approach for a method and apparatus for a durable low latency system architecture in accordance with some embodiments. FIG. 1A juxtaposes a hardware illustration with a software illustration. The hardware illustration shows computing apparatuses with contextual information/callouts illustrating the interaction between hardware and software to form a durable low latency system architecture in accordance with some embodiments. The software illustration shows a hypervisor-based arrangement within which embodiments of the durable low latency system can be implemented.

Node 100 comprises a computing system as illustrated in item 1 containing at least motherboard 109 and a hypervisor 130. Furthermore, while only one node 100 is illustrated, multiple nodes may be similarly arranged as shown by items 2, 3, and 4. The nodes themselves comprise computing systems that receive write request(s) 103 at (1). In some embodiments, the write request(s) 103 received at (1) may be received from one or more user Virtual Machines (e.g. User VM 145a-b) or from one or more external systems, such as another node or any other network connected storage device (e.g. over the Internet). The write requests generally need to be acknowledged prior to the requesting apparatus proceeding with further processing (e.g. such as for SQL database write requests or file system write requests). In response to a received request (e.g. a write request) the processing device(s) 111 stores corresponding data associated with the write request in the volatile memory 113 (see un-committed writes) and updates a data structure to track the stored write requests. By creating a durable volatile memory and storing the received write request information in that durable volatile memory, the write requests can be acknowledged quicker without increasing the risk that the received data would be lost. This is in comparison to storing the write request data in a non-volatile storage which is slower. The volatile memory 113 comprises any type of volatile memory such as Random Access Memory (RAM). After storing corresponding data associate with a write request in the volatile storage, the processor is then available to issue a write acknowledgement and store subsequent write request data. This differs from past techniques in that the data corresponding to the write requests are written to the volatile memory 113 but not the non-volatile memory.

Un-committed writes 104 are persisted to a non-volatile memory (e.g. 114/120) only when additional conditions are met. Additional conditions arise upon the identification of an issue with line power 106. For instance, a power management element 115 receives power from either line power 106 (e.g. wall/grid power generated by a remote power plant) or from a server battery 116 that is within or directly attached to the node 100. The power management unit 115 monitors the line power 106 and upon an identification of a power supply issue at (3) of the line power (e.g. power outage or brown out) switches the power input 112 to the motherboard at (4) to the server battery power 116. Additionally, power management 115 can send or cause the communication of data indicating that there has been an issue with the line power 106 and that the device has been or is being switched to battery power. This would provide for the continued operation of a non-volatile memory 114 embodied as a M.2 storage device, PCI storage device, or any other type of storage device that is powered by the motherboard. Furthermore, in some embodiments, power management 115 provides ongoing or periodic updates as to the health and capacity of the server battery 116. Moreover, in some embodiments power management can be used to supply battery power to a non-volatile memory in the node (e.g. 120) that is not powered by the motherboard 109.

In contrast to prior techniques, where received write requests are always persisted in a non-volatile storage prior to acknowledgement, the present approach does not condition acknowledgement on persisting write requests in a location that is not the target location. Instead the present approach persists corresponding data of write requests in the event of an issue with the line power. Thus, during times that the device is operating on line power, corresponding data for write requests are maintained only in the volatile memory 113 until either a power line issue arises or the corresponding data of the write requests are written to their target location. Here, when processor(s) 111 receive information indicating that there is an issue with line power 106 the processor(s) will begin to process un-committed writes 104 in volatile memory 113 by (a) identifying any un-committed writes (e.g. using a management structure), (b) selecting un-committed writes for persisting from the volatile memory 113, and (c) persist the selected un-committed writes in non-volatile memory 114/120 as persisted write request(s) 107.

Turning now to the software illustration, a controller VM 110a can serve as the software embodiment of the disclosed arrangement. Controller VMs as will be discussed further below are special virtual machines that operate above a hypervisor on each respective node of a plurality of nodes in a cluster and facility access to underlying resources of the cluster such as storage devices. Here the controller VM 110a receives write requests 103 from any of User VMs 145a-b, user VMs on any other node such as nodes 2, 3, and 4, or from any other network attached device with sufficient access privileges. The controller VM 110a is logically situated above the hypervisor 130 in that the controller VM 110a relies on the hypervisor 130 to enable operation. Furthermore, controller VMs on other nodes (e.g. 2, 3, and 4) can cooperate to manage local storage 122/123 comprising any combination of SSDs (see e.g. 125) and HDDs (see e.g. 127) as part of a storage pool 160 as will be discussed further below.

Regardless of the specific arrangement of storage, the hypervisor 130 presents the controller VM 110a with a set of storage devices or volumes constructed from the storage devices and with a portion of RAM. The controller VM 110a utilizes the assigned RAM as volatile memory 113 for maintaining the write request(s) 103. Furthermore, the controller VM 110a receives the power management information and analyzes that power management information to manage the un-committed writes 104 maintained in the assigned portion of RAM. For example, the controller VM 110a may include a process for triggering persisting of un-committed writes 104. The process may include triggering the persisting of the un-committed writes 104 when a power line failure is identified, or notification thereof is received. In some embodiments, the controller VM 110a can specify in which storage device the un-committed writes 104 are to be persisted.

The target location for the write request(s) 103 correspond to any number of locations. For instance, the target locations may comprise network storage 105 such as a storage area network (SAN) or networked attached storage device (NAS). In the alternative, the target storage location may comprise a storage location on a virtual disk (vDisk) that resides on the devices of the storage pool (SSDs 125 and HDDs 127) a set of blocks that are identified using metadata that maps the vDisk location(s) to a block(s) of the storage devices that make up the storage pool 160 (see e.g. SSDs 125 and HDDs 127 where nodes 1, 2, 3, and 4 all contribute storage to the storage pool 160 via at least their respective controller VMs. Thus, the storage pool 160 stores data from at least virtual disks (vDisks). Respective vDisks of a plurality of vDisks correspond to one or more user virtual machines (VMs) 102 that are managed using mapping metadata. Details of how the storage pool 160, vDisks, and user VMs 145a-b are implemented using the vDisk mapping metadata is discussed further in regard to subsequent figures. However, for purposes of the discussion of FIG. 1A the storage pool 160 comprises a logical collection of storage devices (e.g. two or more storage devices) treated as a group, where the data of respective vDisks are distributed across the storage pool as indicated by the vDisk mapping metadata. Furthermore, each user VM of user VMs 102 may be associated with one or more vDisks where the vDisks are owned by a particular VM and may be shared with other VMs through the controller VM.

FIG. 1B illustrates another approach for a method and apparatus for a durable low latency system architecture in accordance with some embodiments. FIG. 1B illustrates an environment in which the any combination of aspects of the disclosure herein can be implemented with a focus on virtualization in the context of a cluster having a storage pool. Additionally, certain elements are identified with an item number previously use to indicate that the element may be the same element and may incorporate any and/or all the previously disclosed aspects.

In some embodiments, the durable low latency system architecture is embodied as clustered virtualization environment, like that illustrated in FIG. 1B including any number of servers (e.g. nodes 100a-b) where each node can service one or more write management functions using controller/service VMs 110a-b or any other notes in the clustered virtualization environment.

FIG. 1B is an alternative representation of at least some aspects of FIG. 1A. Thus, to the extent that FIG. 1B uses like references they are intended to be understood as the same as those in FIG. 1A and the same descriptions above apply in addition to those below.

The architecture of FIG. 1B can be implemented for a distributed platform that contains multiple servers like servers 100a and 100b that manage locally attached storage devices in whole or in part to at least form the storage pool 160. The storage pool may include storage that is accessible through a network 140, such as cloud storage 126 or networked storage 128. Unlike the prior art, the present embodiment also permits local storage 122/124 that is within or directly attached to the server and/or appliance to be managed as part of the storage pool 160. Examples of such storage include SSDs 125 or HDDs 127. These collected storage devices, both local and networked, form a storage pool 160. Virtual disks (or “vDisks”) can be structured from the storage devices in the storage pool 160, as described in more detail below. As used herein, the term vDisk refers to the storage abstraction that is exposed by a controller/service virtual machine to be used by a user virtual machine (VM). In some embodiments, the vDisk is exposed via iSCSI (“internet small computer system interface”) or NFS (“network file system”) and is mounted as a virtual disk on the user VM. For instance, the cluster might comprise 63 nodes equivalent to those illustrated having varying amounts of volatile and non-volatile memory, differing processors, and have controller/service VMs including write managers that present their local storage devices as part of the storage pool to store data blocks for multiple vDisks.

Each server 100a or 100b runs virtualization software, such as VMware ESX(i), Microsoft Hyper-V, or RedHat KVM. The virtualization software includes a hypervisor 130a/130b to manage the interactions between the underlying hardware and the one or more user VMs 102a-b that run client software.

A special VM 110a/110b is used to manage storage and I/O activities according to some embodiment of the invention, which is referred to herein as a “Controller/Service VM”. This is the “Storage Controller” in the currently described architecture. Multiple such storage controllers coordinate within a cluster to form a single storage system. The Controller/Service VMs 110a/110b are not formed as part of specific implementations of hypervisors 130a/130b. Instead, the Controller/Service VMs run as virtual machines above hypervisors 130a/130b on the various servers 102a and 102b, and work together to form a distributed system that manages all the storage resources, including the locally attached storage 122/124, the networked storage 128, and the cloud storage 126. Since the Controller/Service VMs run above the hypervisors 130a/130b, this means that the current approach can be used and implemented within any virtual machine architecture, since the Controller/Service VMs of embodiments of the invention can be used in conjunction with any hypervisor from any virtualization vendor.

Each Controller/Service VM 110a-b exports one or more block devices or NFS server targets that appear as disks to the client VMs 102a-d. These disks are virtual, since they are implemented by the software running inside the Controller/Service VMs 110a-b. Thus, to the user VMs 102a-d, the Controller/Service VMs 110a-b appear to be exporting a clustered storage appliance that contains some disks.

Significant performance advantages can be gained by allowing the virtualization system to access and utilize local (e.g., server-internal) storage 122 as disclosed herein. This is because I/O performance is typically much faster when performing access to local storage 122 as compared to performing access to networked storage 128 across a network 140. This faster performance for locally attached storage 122 can be increased even further by using certain types of optimized local storage devices, such as SSDs 125. Further details regarding methods and mechanisms for implementing the virtualization environment illustrated in FIG. 1B are described in U.S. Pat. No. 8,601,473, which is hereby incorporated by reference in its entirety.

The controller/service VMs 110a-b include write managers 170a-b. These write managers can process the previously discussed write request(s) 103. For instance, the write managers 170a-b may use a portion of volatile memory 113a assigned to the controller service VM 110a-b to manage and store the un-committed write(s) 104 without persisting those un-committed writes 104 as persisted write request(s) 107 in non-volatile memory 114a/120a or 114b/120b respectively. As illustrated the non-volatile memory 114a/120a and 114b/120b respectively are not part of the storage pool 160 but are instead storage space assigned or dedicated to the controller/service VM 110a and 110b respectively—e.g. as a cached or management system. Additionally, in the content of the present disclosure, the non-volatile memories are those directly attached to the node because in the event of a line power issue, persisting un-committed write(s) over a network without providing a sitewide power source is at best unreliable and at worst impossible. However, a sitewide power source, while not the subject of this disclosure, may be combined with the present disclosure to provide a maximum down time.

In some embodiments, the write manager 170a can be provided in any VM such as user VMs 102a-b. For instance, a user VM managing a subscriber database for various electronic mailing lists is provided. The user VM can manage received write requests in the same ways as the controller VM by using a write manager on the user VM. The write manager on the user VM communicates with an external element (e.g. hypervisor or power management element) to request, release, and allocate available battery capacity to received write requests stored in a volatile storage or volatile storage segments for storage of said received write requests. Furthermore, in some embodiments, the received write requests have target locations that are on the storage pool managed by the controller VM, whereas other embodiments have target locations that are not on the storage poll (e.g. dedicated drive or portion thereof on the local machine or remote storage devices such as SANs and cloud storage). Thus, any relevant aspects of the present disclosure can be practice on any VM.

FIG. 1C illustrates an approach for a method and apparatus for a durable low latency system architecture in accordance with some embodiments. Specifically, FIG. 1C illustrates a dual node arrangement with a shared power subsystem.

Here, a server 101 includes an “a” apparatus and a “b” apparatus of the apparatus illustrated in FIG. 1A where the “a” apparatus and the “b” apparatus each correspond to one of the dual nodes. The “a” apparatus includes motherboard 109a similar to motherboard 109, processor(s) 111a similar to processor(s) 111, power in 112a similar to power in 112, volatile memory 113a similar to volatile memory 113, non-volatile memory 114a and 120a similar to non-volatile memory 114 and 120 respectively. Likewise, the “b” apparatus includes motherboard 109b similar to motherboard 109, processor(s) 111b similar to processor(s) 111, power in 112b similar to power in 112, volatile memory 113b similar to volatile memory 113, non-volatile memory 114b and 120b similar to non-volatile memory 114 and 120 respectively.

However, unlike the illustration provided in FIG. 1A the present disclosure includes shared line power 106, power management 115, and server battery 116 as part of the dual node arrangement. In some embodiments, the power management unit provides information to each node representing the total available capacity of the server battery 116 where the nodes can perform an arbitration process to determine what percentage of available capacity is assigned/reserved for each node or virtual machine. In some embodiments, power management 115 provides information to each node indicating only a portion of the actual capacity of server battery 116 is available that corresponds the amounts assigned/reserved for each node.

FIGS. 1D-G illustrate a block 180 according to some embodiments of the invention.

As shown in FIG. 1D, each block 180 can be mounted on a rack with other blocks, and can be instantiated in a chassis that holds multiple nodes A, B, C, and D. Each node corresponds to a serverboard 186 that is insertable into the chassis and which contains one or more processors, memory components, and other hardware components typically found on a motherboard. FIG. 1D shows a perspective view of the block 180, showing the serverboards of the nodes in a partially inserted position. In some embodiments, each serverboard 186 includes power management 115, server battery 116, and line power 106 input.

FIG. 1E shows an end view of the block 180, illustrating the arrangement of the nodes/serverboards 186 in a fully inserted position within the chassis. The block 180 also includes multiple power supply modules 188, e.g., two separate modules as shown in FIG. 1B. This can be used to provide for power redundancy, so that failure of a single power supply module does not bring down the whole block 180. In some embodiments, each power supply includes power management 115 and server battery 116 where power management 115 and server battery 116 are shared, by 2 or 4 nodes/serverboards 186.

FIG. 1F illustrates an end view of a single serverboard 186, showing the various connection points for wiring and peripherals for the serverboard, e.g., network connectors. Each of the serverboards 186 acts as a separate node within the block 180. As independent nodes, each node may be powered on or off separately without affecting the others. In addition, the serverboards 186 are hot swappable and may be removed from the end of the chassis without affecting the operation of the other serverboards. This configuration of multiple nodes ensures hardware-based redundancy of processing and storage capacity for the block, with the storage management software providing for operational redundancies of the data stored and managed by the block.

The block 180 supports multiple local storage devices. In some embodiments, the block 180 includes a backplane that allows connection of six SAS or SATA storage units to each node, for a total of 24 storage units 184 for the block 180. Any suitable type or configuration of storage unit may be connected to the backplane, such as SSDs or HDDs. In some embodiments, any combination of SSDs and HDDs can be implemented to form the six storage units for each node, including all SSDs, all HDDs, or a mixture of SSDs and HDDs.

FIG. 1G shows an end view of the portion of the block/chassis corresponding to the storage units. Each of the individual storage units 184 are insertable into the chassis of block 180. In addition, the storage units are hot swappable and may be removed from the end of the chassis without affecting the operation of the other storage units. This configuration of multiple storage units ensures hardware-based redundancy of the storage capacity for the block.

The entirety of the block 180 fits within a “2u” or less form factor unit. A rack unit or “u” (also referred to as a “RU”) is a unit of measure used to describe the height of equipment intended for mounting in a rack system. In some embodiments, one rack unit is 1.75 inches (44.45 mm) high. This means that the 2u or less block provides a very space-efficient and power-efficient building block for implementing a virtualized data center. The redundancies that are built into the block mean that there is no single point of failure that exists for the unit. The redundancies also mean that there is no single point of bottleneck for the performance of the unit. The blocks are rackable as well, with the block being mountable on a standard 19″ rack.

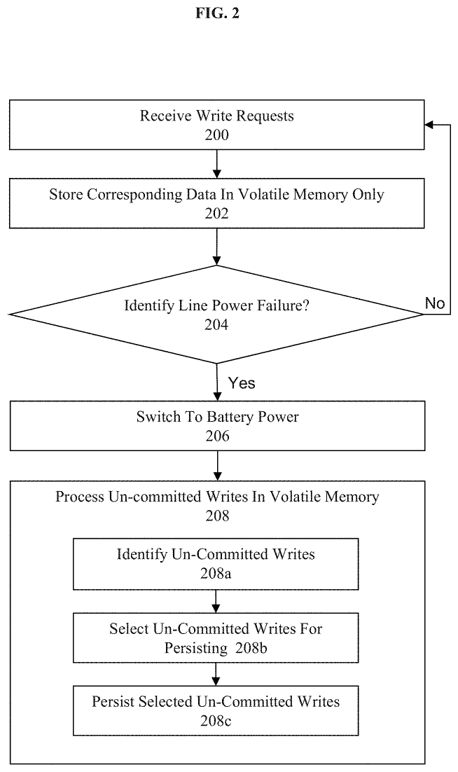

FIG. 2 illustrates a flowchart for a durable low latency system architecture in accordance with some embodiments.

The process starts at 200 where write requests are received. As discussed above, write requests can be received from user VMs on the node or from other nodes or other devices with sufficient authorization. For instance, one or more requests to access a first vDisk managed by the controller VM on the same node from a user VM on that node, where the vDisk is assigned to that user VM. Additionally, one or more requests might be received from a user VM on the same machine that is authorized to access a user VM assigned to a different user VM. Furthermore, one or more access requests might be received from other nodes in the same cluster or a different cluster. Finally, one or more access requests might be received from one or more devices that are not part of the cluster via various network connections (e.g. over the Internet) to access one or more vDisks or other data managed by the controller VM.

Upon receipt, data corresponding to the received write requests are stored in the volatile memory at 202 without persisting that corresponding data to a non-volatile memory device. In this way, bandwidth consumption is minimized by avoiding writing the data into a slower persistent storage location. Furthermore, processing resources are minimized because management data structures do not have to be updated with information that can be used for identifying where in a persistent storage location (e.g. non-volatile cache). Additionally, at 202 management data is updated to help manage the corresponding write requests. For instance, a list or table structure is maintained cataloging write requests stored in the volatile memory. Each request may be associated with a receipt sequence number, a logical sequence number a value indicating that the write request has or has not been written to a persistent storage (such as in response to a power line failure), the location of the persisted storage location in a cache structure, a value indicating whether the write request data has been written to the target storage location (e.g. to manage write request data in the volatile storage for servicing subsequent access requests). In some embodiments, the management data is maintained in volatile memory and non-volatile memory where the non-volatile memory version represents a backup copy that is updated periodically or based on a triggering event (e.g. a new entry or number of entries have been added to the version stored in volatile memory).

After a number of write request(s) are received and stored in the volatile memory a line power failure might be identified at 204. For instance, a power management circuit element and or software element combination that monitors the line power current and voltage identifies a drop in the voltage on the line power below a specified threshold and possibly for a minimum time. As a result, the system at 206 switches to battery power and provides information to the processor(s) indicating that the device has been switched to battery power—e.g. raises a non-maskable interrupt to initiate the processing of un-committed writes in volatile memory at 208. However, while no line power failure is identified the process continues to receive write requests at 200 and store corresponding data in volatile memory only at 202.

The processing of un-committed writes in volatile memory of 208 comprises at least three sub-steps, identifying un-committed writes at 208a, selecting un-committed writes for persisting at 208b, and persisting the selected un-committed writes at 208c.

At 208a, the un-committed writes are identified. For example, the un-committed writes are identified by processing a data structure for managing the data corresponding to the received write requests—e.g. by performing a lookup operation on the data structure to identify the entries that have a value indicating that the data has not yet been persisted in its target location—e.g. not yet written to their final database or file system location.

At 208b, the un-committed writes identified in 208a are selected for persisting. For instance, an entry number or other identifier is used to generate a list of un-committed write requests to be persisted in a locally attached non-volatile storage device.

At 208c, the selected un-committed writes for persisting are persisted. One possible way this can be done is by processing the list or table to generate and process write commands on the non-volatile storage device. For instance, the write manager in the controller/service VM generates a series of write commands that it sends to the hypervisor, which passes them on the appropriate drive controller (e.g. SSD or HDD controllers) which ultimately writes the specified data to an indicated storage device in a non-volatile storage area that is assigned to the controller VM (see e.g. non-volatile memory 114, 120, 114a/120a, or 114b/120b).

Furthermore, in some embodiments, the switch to battery power triggers a change in behavior of the write manager in that the write manner and or controller/service VM will stop acknowledging received write requests while on battery power. In this way, the write manner and or controller/service VM can insure that it does not acknowledge write requests that it will likely be unable to complete because battery power is short lived.

Additionally, in some embodiments the write manager includes a process or processes for insuring that the amount of write request data that is un-committed does not exceed the available battery capacity. For instance, the write manager may include logic for determining the minimum operational time provided by the available/assigned battery capacity—e.g. by maintaining power consumption data for the devices powered by the motherboard and for non-volatile memory where un-committed write requests are to be persisted. Power consumption data specifies the max power of the devices powered by the motherboard or any other devices that are powered from the battery separately from the motherboard. Additional specifications can be maintained for determining the amount of time required for persisting the un-committed data in the non-volatile memory—e.g. maximum throughput less headroom required for protocol exchanges to implement the persisting. This data is then used to either periodically or upon receipt of a write request, determine whether the current amount of un-persisted data exceeds the amount of data that can be persisted based on a current battery capacity level available or assigned.

If the un-committed data in the non-volatile memory exceeds the amount of data that can be persisted based on a current battery capacity level, data can be persisted using other/additional methods. For instance, data can be written to its target storage location (thereby decreasing the amount of un-committed data), data can be persisted in non-volatile memory caching structure to decrease the amount of data in the non-volatile storage that needs the battery backup, data can be persisted using a snapshot process that takes periodic or event triggered (e.g. by excess or near excess un-committed data) of either the un-persisted write requests or of all write requests having corresponding data stored in the volatile memory. Furthermore, in some embodiments, snapshots can be taken of relevant data in the volatile and non-volatile memory.

In some embodiments, the corresponding write request data can be preprocessed in various ways prior to storage in a target location. For instance, corresponding write request data can be batched within the non-volatile memory to match the native block size of a target storage device or a group size of a volume management structure (e.g. extents). Furthermore, in some embodiments duplicate write requests to the same target location can be eliminated, such as when a first write request to a target location is received, followed by a second write request that corresponds to the same target location as the first write request. Thus, the second write request renders the performance of the first write request data moot (in the present disclosure this may also avoid ever persisting the first write request). Additionally, in some embodiments, compression, deduplication, erasure coding generation, dictionary compression (value tokenization), and building block-level summary (e.g. min/max and bloom filters) can be completed in one or more preprocessing steps prior to storage in a target location.

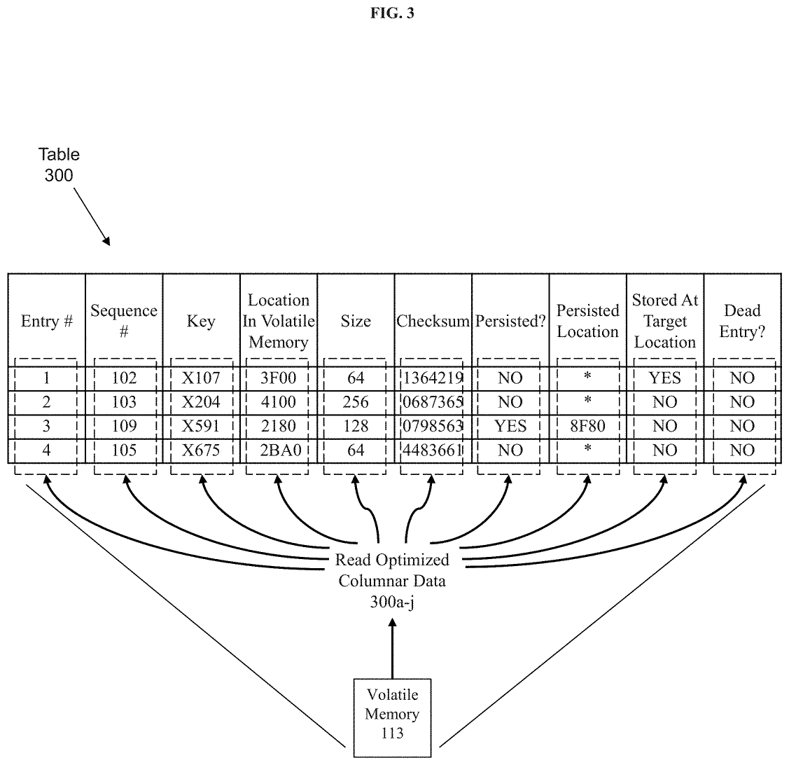

In some embodiments, the write manager includes a memory cleaner process where the memory cleaner process analyses the management data to identify or mark entries for replacement or removal. Thus, old entries that have already been persisted in their target location can be removed or replaced with new entries yet to be persisted in their target location. In some embodiments, the memory cleaner uses one or more thresholds and parameters to determine which entries are identified or marked such as describe herein in regard to FIG. 3.

FIG. 3 illustrates an example table for managing write request data for a durable low latency system architecture in accordance with some embodiments.

As illustrated, the volatile memory 113 includes table 300. The volatile memory 113 corresponds to volatile memory 113 discussed in previous figures. Here, table 300 is arrange as a series of rows and columns and represents data usable for management of received write requests. For instance, each column corresponds to a particular type of value identified by the header at the top of the column, each row corresponds to a particular entry, and each cell within each row can be populate with a value that corresponds to the header.

The table 300 is organized in memory as a series of columnar data sets (see 300a-j), where each columnar data set is stored as a separate series of data values in the volatile memory 113. By arranging the data in a columnar format, the table is read optimized in contrast to a row-oriented data format which is write optimized. Read optimization minimizes the amount of data that must be sorted through to identify the desired information—e.g. each type of data is arranged as one contiguous set of values. Write optimized data is organized such that writing can be completed using a minimum number of locations—e.g. the data for each entry is written as one contiguous set of values. For instance, to select the checksum from the table using a key value (e.g. X591) the columnar data for 300c would have to be searched to find the location of the matching key value (the third entry). Using the location information, the checksum value at the third location of the columnar dataset for the checksum column (300f) can be searched to identify the third entry (0798563).

In some embodiments, columnar data includes any combination of an entry # (300a), a sequence number (300b), a key or identifier (300c), a location in volatile memory (300d), a data size (300e), a checksum value (300f), a value indicating whether corresponding data has been persisted (300g), a location in which corresponding data has been persisted if it has been persisted (300h), a value indicating whether corresponding data has been stored at its target location (300i), and a value indicating whether the entry is valid or dead (300j).

The entry # column corresponds to an entry number or position with the table. As illustrated, there are four entries having values 1-4 in subsequent rows identified by the entry #. In some embodiments, the entry # corresponds to an offset used to identify entries in other fields.

The sequence # column corresponds to a write request sequence number. Sequence numbers can be used to maintain sequential relationships between the entries. For instance, sequence numbers can be used to ensure that logically preceding write requests are written before subsequent write requests.

The key column corresponds to an identifier for the corresponding write request. For instance, a key column value is used by the controller VM to determine the target storage location for the data in the storage pool.

The location in volatile memory column identifies where in the volatile memory the corresponding data is store. Likewise, the persisted location column identifies where in non-volatile memory (e.g. non-volatile memory 114 or 120) the corresponding data is stored in the event that the value is stored in the non-volatile memory. Additionally, the size column holds values indicating the size of the corresponding data (e.g. 64 bits). The checksum column contains corresponding checksum values that can be used to validate the stored data. Finally, the dead entry column can be used to mark entries as invalid. For instance, if the data is corrupted, if the data has been replaced by a subsequent write, or if the data has been overwritten and/or marked as available for other data to take its place, whether for the write management processes or for another process.

In some embodiments, additional values are included in table 300 or in another data storage structure. For instance, an additional value representing the frequency of access or number of accesses over a given time window (e.g. a sliding time window). In some embodiments, the additional values are used to select write requests to be committed. Write requests can be selected based on any number of criteria. For example, based on the time the write request was received, based on the frequency or number of accesses to the corresponding data, or some combination thereof. Additionally, one or more thresholds can be determine based on one or more characteristics of the collection of received write requests and the available storage capacity in volatile memory—e.g. minimum access frequency/number, maximum age, or some combination thereof. Where the thresholds are adjusted based on the one or more characteristics (e.g. the minimum access frequency/number and/or maximum age or a combination thereof can be adjusted to provide for more or less aggressive write request storage/retirement behavior. To illustrate, as the available storage is consumed, the minimum access frequency/number is increased while the maximum age is decreased. Thus, the available storage can be managed to maintain the corresponding write request data that has been (and presumably will continue to be) the most useful for storing in volatile memory because it is the most likely to be access.

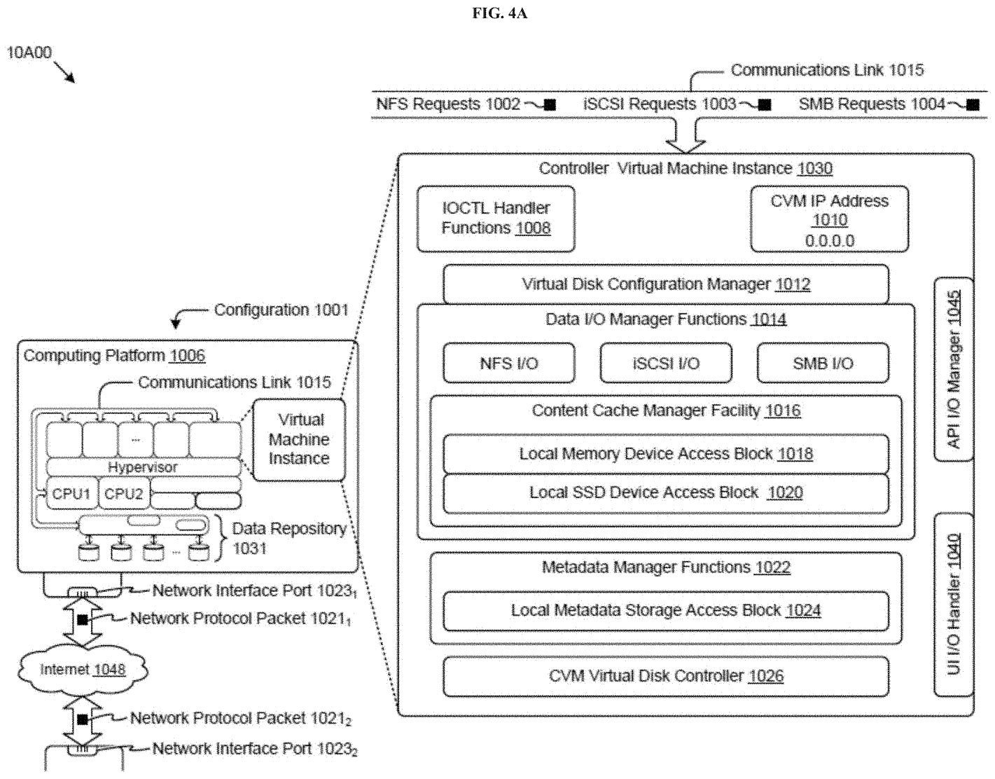

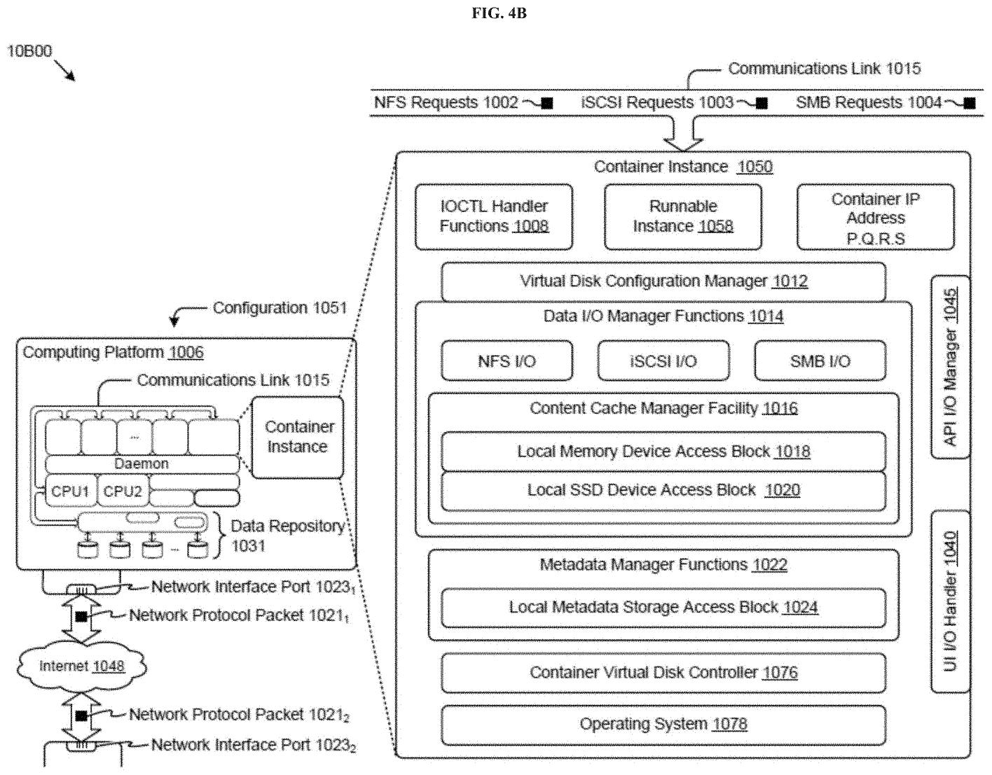

FIG. 4A illustrates a virtualized controller as implemented by the shown virtual machine architecture in which some embodiments are implemented. FIG. 4A depicts a virtualized controller as implemented by the shown virtual machine architecture 10A00. The heretofore-disclosed embodiments including variations of any virtualized controllers can be implemented in distributed systems where a plurality of networked-connected devices communicate and coordinate actions using inter-component messaging. Distributed systems are systems of interconnected components that are designed for or dedicated to storage operations as well as being designed for, or dedicated to, computing and/or networking operations. Interconnected components in a distributed system can operate cooperatively to serve a particular objective, such as to provide high-performance computing, high-performance networking capabilities, and/or high-performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyper converged system coordinates efficient use of compute and storage resources by and between the components of the distributed system. Adding a hyper converged unit to a hyper converged system expands the system in multiple dimensions. As an example, adding a hyper converged unit to a hyper converged system can expand in the dimension of storage capacity while concurrently expanding in the dimension of computing capacity and in the dimension of networking bandwidth. Components of any of the foregoing distributed systems can comprise physically and/or logically distributed autonomous entities.

Physical and/or logical collections of such autonomous entities can sometimes be referred to as nodes. In some hyper converged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyper converged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as containers. In some systems and/or environments, hypervisor-assisted virtualization techniques and operating system virtualization techniques are combined.

As shown, the virtual machine architecture 10A00 comprises a collection of interconnected components suitable for implementing embodiments of the present disclosure and/or for use in the herein-described environments. Moreover, the shown virtual machine architecture 10A00 includes a virtual machine instance in a configuration 1001 that is further described as pertaining to the controller virtual machine instance 1030. A controller virtual machine instance receives block I/O (input/output or IO) storage requests as network file system (NFS) requests in the form of NFS requests 1002, and/or internet small computer storage interface (iSCSI) block IO requests in the form of iSCSI requests 1003, and/or Samba file system (SMB) requests in the form of SMB requests 1004. The controller virtual machine (CVM) instance publishes and responds to an internet protocol (IP) address (e.g., CVM IP address 1010). Various forms of input and output (I/O or IO) can be handled by one or more IO control handler functions (e.g., IOCTL functions 1008) that interface to other functions such as data IO manager functions 1014 and/or metadata manager functions 1022. As shown, the data IO manager functions can include communication with a virtual disk configuration manager 1012 and/or can include direct or indirect communication with any of various block IO functions (e.g., NFS IO, iSCSI IO, SMB IO, etc.).

In addition to block IO functions, the configuration 1001 supports IO of any form (e.g., block IO, streaming IO, packet-based IO, HTTP traffic, etc.) through either or both of a user interface (UI) handler such as UI IO handler 1040 and/or through any of a range of application programming interfaces (APIs), possibly through the shown API IO manager 1045.

The communications link 1015 can be configured to transmit (e.g., send, receive, signal, etc.) any types of communications packets comprising any organization of data items. The data items can comprise payload data, a destination address (e.g., a destination IP address), and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. Additionally, the payload may comprise a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 1030 includes a content cache manager facility 1016 that accesses storage locations, possibly including local dynamic random access memory (DRAM) (e.g., through the local memory device access block 1018) and/or possibly including accesses to local solid state storage (e.g., through local SSD device access block 1020).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 1031, which in turn can be formatted into any one or more storage areas, and which can comprise parameterized storage accessible by a key (e.g., a filename, a table name, a block address, an offset address, etc.). An external data repository 1031 can store any forms of data and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 1024. The external data repository 1031 can be configured using a CVM virtual disk controller 1026, which can in turn manage any number or any configuration of virtual disks.

Execution of the sequences of instructions to practice certain embodiments of the disclosure are performed by one or more processors, or a processing element such as a data processor, or such as a central processing unit (e.g., CPU1, CPU2). According to certain embodiments of the disclosure, two or more instances of a configuration 1001 can be coupled by a communications link 1015 (e.g., backplane, LAN, PSTN, wired or wireless network, etc.) and each instance may perform respective portions of sequences of instructions as may be required to practice embodiments of the disclosure.

The shown computing platform 1006 is interconnected to the Internet 1048 through one or more network interface ports (e.g., network interface port 1023₁ and network interface port 1023₂). The configuration 1001 can be addressed through one or more network interface ports using an IP address. Any operational element within computing platform 1006 can perform sending and receiving operations using any of a range of network protocols, possibly including network protocols that send and receive packets (e.g., network protocol packet 1021₁ and network protocol packet 1021₂).

The computing platform 1006 may transmit and receive messages that can be composed of configuration data, and/or any other forms of data and/or instructions organized into a data structure (e.g., communications packets). In some cases, the data structure includes program code instructions (e.g., application code) communicated through the Internet 1048 and/or through any one or more instances of communications link 1015. Received program code may be processed and/or executed by a CPU as it is received and/or program code may be stored in any volatile or non-volatile storage for later execution. Program code can be transmitted via an upload (e.g., an upload from an access device over the Internet 1048 to computing platform 1006). Further, program code and/or results of executing program code can be delivered to a particular user via a download (e.g., a download from the computing platform 1006 over the Internet 1048 to an access device).

The configuration 1001 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. The first partition and second partition can be congruent (e.g., in a processing element array) or can be different (e.g., comprising disjoint sets of components).

A cluster is often embodied as a collection of computing nodes that can communicate between each other through a local area network (e.g., LAN or VLAN) or a backplane. Some clusters are characterized by assignment of a set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provision of power to the other units. In some cases, a unit in a rack is dedicated to environmental conditioning functions such as filtering and movement of air through the rack, and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets or can be configured as one VLAN. Multiple clusters can communicate between one module to another over a WAN (e.g., when geographically distal) or LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Further details regarding general approaches to managing data repositories are described in U.S. Pat. No. 8,601,473 titled, “ARCHITECTURE FOR MANAGING I/O AND STORAGE FOR A VIRTUALIZATION ENVIRONMENT” issued on Dec. 3, 2013 which is hereby incorporated by reference in its entirety.

Further details regarding general approaches to managing and maintaining data in data repositories are described in U.S. Pat. No. 8,549,518 titled, “METHOD AND SYSTEM FOR IMPLEMENTING MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 4B illustrates a virtualized controller implemented by a containerized architecture in which some embodiments are implemented. FIG. 4B depicts a virtualized controller implemented by a containerized architecture 10B00. The containerized architecture comprises a collection of interconnected components suitable for implementing embodiments of the present disclosure and/or for use in the herein-described environments. Moreover, the shown containerized architecture 10B00 includes a container instance in a configuration 1051 that is further described as pertaining to the container instance 1050. The configuration 1051 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any container (e.g., container instance 1050). A container instance can be executed by a processor. Runnable portions of a container instance sometimes derive from a container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container instance (e.g., a Docker container) can serve as an instance of an application container. Any container of any sort can be rooted in a directory system and can be configured to be accessed by file system commands (e.g., “ls” or “ls -a”, etc.). The container might optionally include operating system components 1078, however such a separate set of operating system components need not be provided. As an alternative, a container can include a runnable instance 1058, which is built (e.g., through compilation and linking, or just-in-time compilation, etc.) to include all the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 1076. Such a container virtual disk controller can perform any of the functions that the CVM virtual disk controller 1026 can perform, yet such a container virtual disk controller does not rely on a hypervisor or any particular operating system to perform its range of functions.

In some environments multiple containers can be collocated and/or can share one or more contexts. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

Embodiments as disclosed herein may be implemented in both the virtual machine architecture 10A00 or the containerized architecture 10B00.

### System Architecture

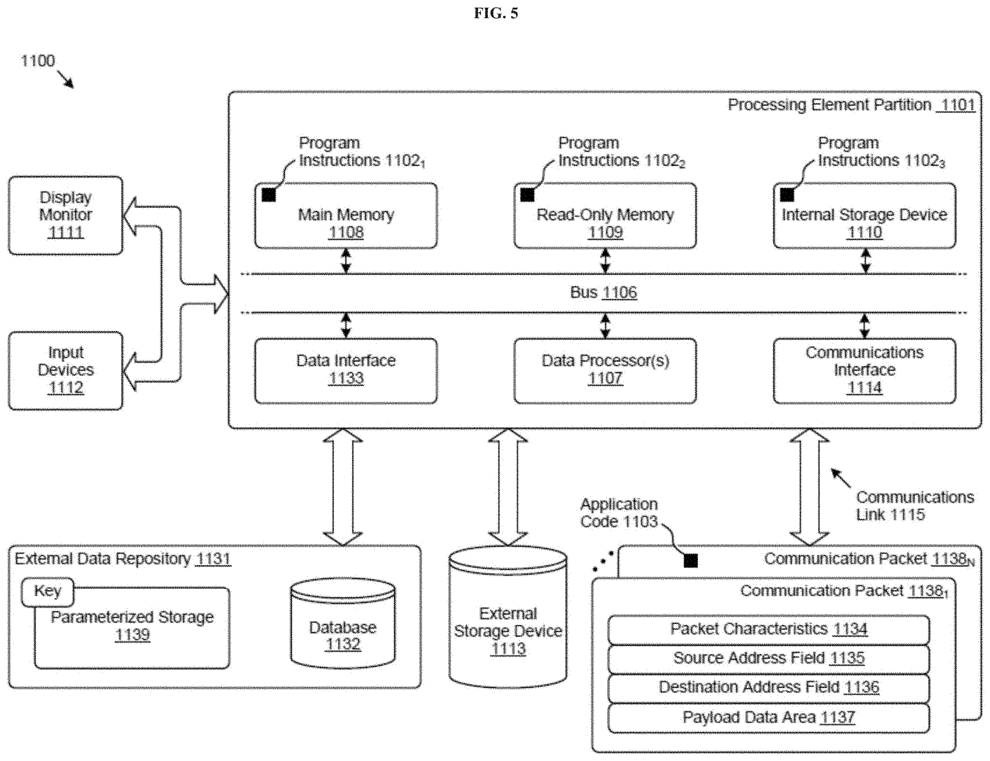

FIG. 5 depicts a block diagram of an instance of a computer system 1100 suitable for implementing embodiments of the present disclosure. Computer system 1100 includes a bus 1106 or other communication mechanism for communicating information. The bus interconnects subsystems and devices such as a CPU, or a multi-core CPU (e.g., data processor 1107), a system memory (e.g., main memory 1108, or an area of random access memory (RAM)), a non-volatile storage device or non-volatile storage area (e.g., read-only memory 1109), an internal storage device 1110 or external storage device 1113 (e.g., magnetic or optical), a data interface 1133, a communications interface 1114 (e.g., PHY, MAC, Ethernet interface, modem, etc.). The aforementioned components are shown within processing element partition 1101, however other partitions are possible. The shown computer system 1100 further comprises a display 1111 (e.g., CRT or LCD), various input devices 1112 (e.g., keyboard, cursor control), and an external data repository 1131.

According to an embodiment of the disclosure, computer system 1100 performs specific operations by data processor 1107 executing one or more sequences of one or more program code instructions contained in a memory. Such instructions (e.g., program instructions 11021, program instructions 11022, program instructions 11023, etc.) can be contained in or can be read into a storage location or memory from any computer readable/usable medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 1100 performs specific networking operations using one or more instances of communications interface 1114. Instances of the communications interface 1114 may comprise one or more networking ports that are configurable (e.g., pertaining to speed, protocol, physical layer characteristics, media access characteristics, etc.) and any particular instance of the communications interface 1114 or port thereto can be configured differently from any other particular instance. Portions of a communication protocol can be carried out in whole or in part by any instance of the communications interface 1114, and data (e.g., packets, data structures, bit fields, etc.) can be positioned in storage locations within communications interface 1114, or within system memory, and such data can be accessed (e.g., using random access addressing, or using direct memory access DMA, etc.) by devices such as data processor 1107.

The communications link 1115 can be configured to transmit (e.g., send, receive, signal, etc.) any types of communications packets (e.g., communications packet 1138₁, communications packet 1138_{N}) comprising any organization of data items. The data items can comprise a payload data area 1137, a destination address 1136 (e.g., a destination IP address), a source address 1135 (e.g., a source IP address), and can include various encodings or formatting of bit fields to populate the shown packet characteristics 1134. In some cases, the packet characteristics include a version identifier, a packet or payload length, a traffic class, a flow label, etc. In some cases, the payload data area 1137 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 1107 for execution. Such a medium may take many forms including, but not limited to, non-volatile media and volatile media. Non-volatile media includes, for example, optical or magnetic disks such as disk drives or tape drives. Volatile media includes dynamic memory such as a random access memory.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 1131, which in turn can be formatted into any one or more storage areas, and which can comprise parameterized storage 1139 accessible by a key (e.g., filename, table name, block address, offset address, etc.).

Execution of the sequences of instructions to practice certain embodiments of the disclosure are performed by a single instance of the computer system 1100. According to certain embodiments of the disclosure, two or more instances of computer system 1100 coupled by a communications link 1115 (e.g., LAN, PTSN, or wireless network) may perform the sequence of instructions required to practice embodiments of the disclosure using two or more instances of components of computer system 1100.

The computer system 1100 may transmit and receive messages such as data and/or instructions organized into a data structure (e.g., communications packets). The data structure can include program instructions (e.g., application code 1103), communicated through communications link 1115 and communications interface 1114. Received program code may be executed by data processor 1107 as it is received and/or stored in the shown storage device or in or upon any other non-volatile storage for later execution. Computer system 1100 may communicate through a data interface 1133 to a database 1132 on an external data repository 1131. Data items in a database can be accessed using a primary key (e.g., a relational database primary key).

The processing element partition 1101 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. The first partition and the second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 1107. Some embodiments include one or more special-purpose hardware components (e.g., power control, logic, sensors, transducers, etc.).

Various implementations of the database 1132 comprise storage media organized to hold a series of records or files such that individual records or files are accessed using a name or key (e.g., a primary key or a combination of keys and/or query clauses). Such files or records can be organized into one or more data structures Such files or records can be brought into and/or stored in volatile or non-volatile memory.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A non-transitory computer readable medium having stored thereon a sequence of instructions which, when executed by a processor causes a set of acts comprising:
receiving a write request at a computing node, the computing node coupled to a backup battery power source and a non-battery power source;
storing the write request in a volatile memory of the computing node; and
committing the write request in non-volatile storage, the write request being maintained durably in the volatile memory by backup battery power of the backup battery power source.

2. The computer readable medium of claim 1, wherein committing the write request is in response to identifying a failure of the non-battery power source and switching to the backup battery power source.

3. The computer readable medium of claim 1, wherein the write request is received from a user virtual machine.

4. The computer readable medium of claim 1, wherein the write request is received from a user virtual machine operating on the computing node.

5. The computer readable medium of claim 1, wherein the write request is received from a user virtual machine is operating on a second computing node different from the computing node.

6. The computer readable medium of claim 1, further comprising: managing, by a virtual machine on the computing node, a storage device locally attached to the computing node, and managing, by a second virtual machine on second computing node, a second storage device locally attached to the second computing node.

7. The computer readable medium of claim 1, further comprising acknowledging receipt of the write request after storing the write request in the volatile memory and before processing the write request in the volatile memory to persist the write requests.

8. The computer readable medium of claim 2, wherein the backup battery power source is provided by a battery electrically coupled to a motherboard of the computing node.

9. The computer readable medium of claim 2, wherein the backup battery power source is provided by a battery electrically coupled to a first motherboard of the computing node and a second motherboard of a second computing node.

10. The computer readable medium of claim 1, wherein the write request is committed based on at least a frequency of access or a number of accesses.

11. The computer readable medium of claim 2, further comprising identifying the write request as an un-committed write request before committing the write request in the non-volatile storage.

12. The computer readable medium of claim 6, wherein the virtual machine and the second virtual machine maintain at least shared metadata to manage the storage device and the second storage device as part of a storage pool, and the write request has a target storage location on a virtual disk stored on the storage pool.

13. The computer readable medium of claim 1, wherein the write request is received at a virtual machine on the computing node.

14. The computer readable medium of claim 1, wherein the non-volatile memory is directly attached to a motherboard of the computing node.

15. The computer readable medium of claim 1, wherein the non-volatile memory receives power directly from a motherboard of the computing node.

16. A method comprising:
receiving a write request at a virtual machine on a computing node, the computing node coupled to a backup battery power source and a non-battery power source;
storing the write request in a volatile memory of the computing node; and
committing the write request in non-volatile storage, the write request being maintained durably in the volatile memory by backup battery power of the backup battery power source.

17. The method of claim 16, wherein committing the write request is in response to identifying a failure of the non-battery power source and switching to the backup battery power source.

18. The method of claim 16, wherein the write request is received from a user virtual machine.

19. The method of claim 16, wherein the write request is received from a user virtual machine operating on the computing node.

20. A computing system comprising:
a memory for storing a sequence of instructions; and
a processor that executes the sequence of instructions
receiving a plurality of write request at a virtual machine on a computing node, the computing node coupled to a backup battery power source and a non-battery power source;
storing the write request in a volatile memory of the computing node; and
committing the write request in non-volatile storage, the write request being maintained durably in the volatile memory by backup battery power of the backup battery power source.
